(19) United States
(12) Patent Application Publication
(10) Pub. No.: US 2005/0243671 A1
(43) Pub. Date: Nov. 3, 2005

(54) Compensation method for front monitor diode

(75) Inventor: Po-Wei Chang, Chu Pei City (TW)

Correspondence Address: BIRCH STEWART KOLASCH & BIRCH, PO BOX 747, FALLS CHURCH, VA, 22040-0747, US

(73) Assignee: MEDIATEK INCORPORATION

(21) Appl. No.: 11/097,217

(22) Filed: Apr. 4, 2005

(30) Foreign Application Priority Data
Apr. 30, 2004 (TW) 93112273

(51) Int. Cl. G11B 20/00

(52) U.S. Cl. 369/53.1

(57) ABSTRACT

A compensation method for a front monitor diode of optical disk recorder is proposed for operation in high power operation. A lookup table is established offline by measuring voltage reduction of reading voltage for the front monitor diode with respect to a specific writing voltage. The reading voltage measured by the front monitor diode is compensated for by a reading bias voltage with reference to the lookup table and writing voltage. Therefore, the servo controller can produce stable servo signals to ensure recording quality.

### BACKGROUND OF THE INVENTION

1. Field of the Invention

The present invention relates to a compensation method used in an optical disk recorder, especially to a method of compensating for output voltage deviation of a front monitor diode (FMD) for high power recording in an optical disk recorder.

2. Description of Related Art

The conventional optical disk recorder generally has an auto power control (APC) system to control the writing power of a laser diode at different environment temperatures. More particularly, a front monitor diode (FMD) is provided to measure the output light intensity of the laser diode in the optical pickup head to stabilize the output characteristic of the laser diode even in a high-temperature environment. The APC system uses the detection result of the front monitor diode to feedback control the laser diode. The driving current to the laser diode is increased when the detection result of the front monitor diode is lower than an expected value, and the driving current to the laser diode is decreased when the detection result of the front monitor diode is higher than the expected value.

FIG. 1 shows a schematic view of a prior art APC system. The APC system 110 uses a front monitor diode 115 to measure the output light intensity of the laser diode and a sampling circuit 117 to sample the measurement of the front monitor diode 115.

The front monitor diode 115 generally has good thermal immunity to provide precise result for high temperature operation. However, the front monitor diode 115 cannot provide precise measurement during high power operation due to limited time response thereof.

FIG. 2A is a schematic view of a measurement result of the front monitor diode 115 in high power operation. It should be noted the output of the front monitor diode 115 is an inverted result. Therefore, the lower curve corresponds to the measurement of writing voltage 21 and the higher curve corresponds to the measurement of reading voltage 23.

In high power operation, the writing power and reading power of the laser diode in the optical pickup 113 has greater difference. The front monitor diode 115 will output incorrectly measured reading voltage 27 at sampling point 25 due to limited time response thereof. In other word, the front monitor diode 115 will not output a correct settled reading voltage 23 at sampling point 25.

FIG. 2B is a schematic view of measurement result of the front monitor diode 115 during lower power operation. In lower power operation, the writing power and reading power of the laser diode in the optical pickup 113 has a smaller difference. Therefore, the measured reading voltage 27′ at sampling point 25′ is equivalent to correct settled reading voltage 23′. As can be seen in the above description, the measured reading voltage 27 will be lower than the real reading voltage 23. Therefore, the APC system will make an incorrect judgment that the reading voltage is excessive. The reading power will then be reduced. As a result, the servo controller of the optical disk recorder will not have stable operation.

### SUMMARY OF THE INVENTION

It is the object of the present invention to provide a method for compensating output voltage deviation of the front monitor diode for high power recording.

To achieve above object, the present invention provides a method of compensating for a front monitor diode, comprising steps of: the front monitor diode measuring a writing voltage from a laser diode; obtaining a reading bias voltage from a lookup table, the lookup table being prepared offline by measuring a reduction of reading voltage of the front monitor diode for a specific writing voltage; and an auto power control unit sending a compensated reading power to the laser diode.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings, in which:

FIG. 1 shows a schematic view of a prior art APC system;

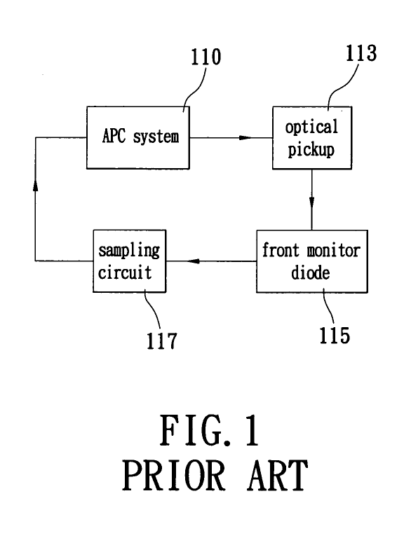

FIGS. 2A and 2B are schematic views of measurement results of the front monitor diode;

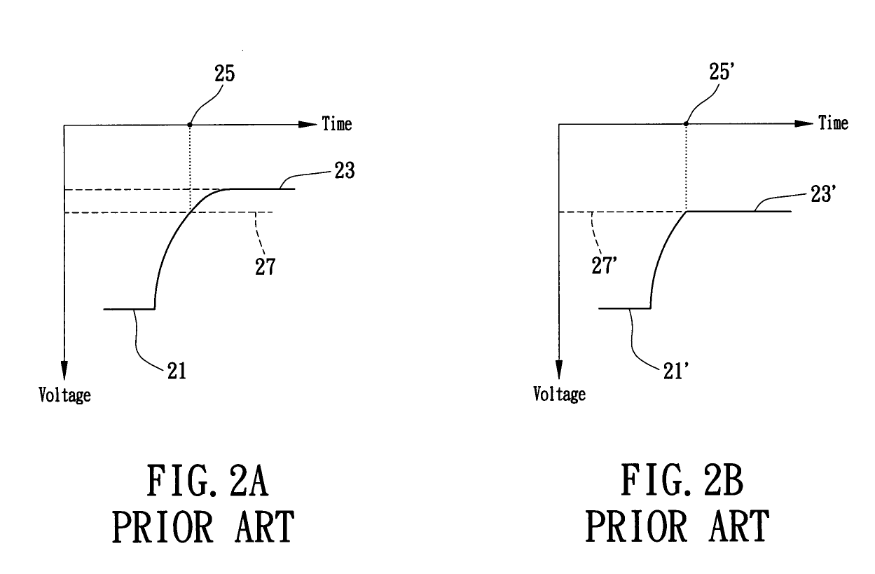

FIG. 3 shows an apparatus for realizing the compensating method according to the present invention;

FIG. 4 is a schematic view showing the compensation for the measured reading voltage in high power operation; and

FIG. 5 shows the flowchart of the compensating method according to the present invention.

### DETAILED DESCRIPTION OF PREFERRED EMBODIMENTS

The present invention is intended to provide a method of compensating for output voltage deviation of the front monitor diode during high power recording. Therefore, the servo controller of the optical disk recorder has a stable servo signal for recording operation.

To overcome the output voltage deviation of the front monitor diode during high power recording, the method according to the present invention provides a compensation table for reading voltage corresponding to various writing voltage value. The compensation table can be prepared in an offline manner and created, for example, by interpolating the measured reading voltages, which are measured offline and are a correct value. Therefore, the loop gain of the auto power control (APC) system can be kept stable during high power recording operation. The servo controller of the optical disk recorder has a stable servo signal for a recording operation.

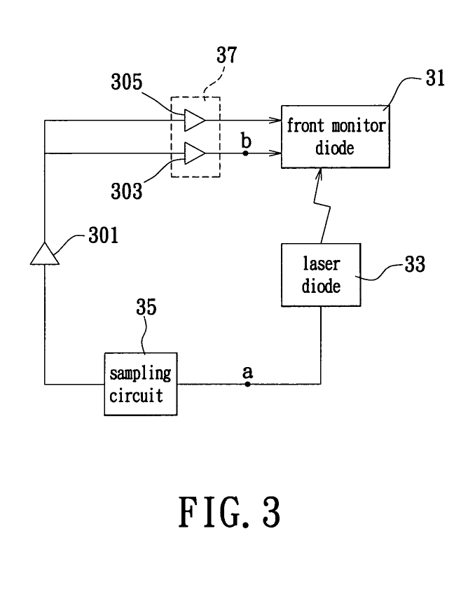

FIG. 3 shows an apparatus for realizing the compensating method according to the present invention. The compensating apparatus is used to compensate for the measured output voltage for the laser diode 31.

As shown in FIG. 3, the front monitor diode 31 monitors the writing power and reading power of the laser diode 33 by outputting associated writing and reading voltages. Generally, a writing operation is followed by a reading operation to determine parameters for servo control. In the writing operation, the APC 37 sends a writing voltage to the laser diode 31 at a writing voltage end 305. At this time, a sampling circuit 35 samples the output of the front monitor diode 31 at reference point a to obtain the writing voltage value for the laser diode. The compensating apparatus has a bias voltage unit 301 storing the voltage compensation bias of reading voltage for different writing voltage. The bias voltage unit 301 will send a reading bias voltage corresponding to the sampled writing voltage at reference point a to the APC 37. The APC 37 will add this reading bias to the measured reading voltage to obtain a compensated reading voltage. The compensated reading voltage is output by a reading voltage end 305 of the APC 37 and sent to the laser diode 31 through the reference point b.

In above-mentioned compensating apparatus, the reading bias voltage is the difference between the measured reading voltage at reference point a and the compensated reading voltage at reference point b. The reading bias voltage is prepared in an offline manner and stored in a lookup table in the bias voltage unit 301. The resolution of the reading bias voltage can be refined by interpolation.

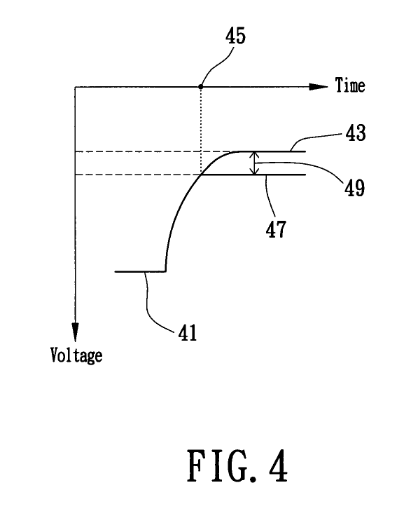

FIG. 4 is a schematic view showing the compensation for the measured reading voltage in high power operation, where the abscissa indicates time and the ordinate indicates voltage. The front monitor diode 31 generally has a limited time response such that the sampling point 45 is a fixed point on the abscissa. During high power operation, there is a larger difference between writing voltage and reading voltage. The front monitor diode 31 will obtain a measured reading voltage 43 at sampling point 45 due to a limited time response. The bias voltage unit 301 will determine a reading bias voltage 49 with reference to the writing voltage 41. The reading bias voltage 49 is added to the measured reading voltage 43 to obtain a compensated reading voltage 47.

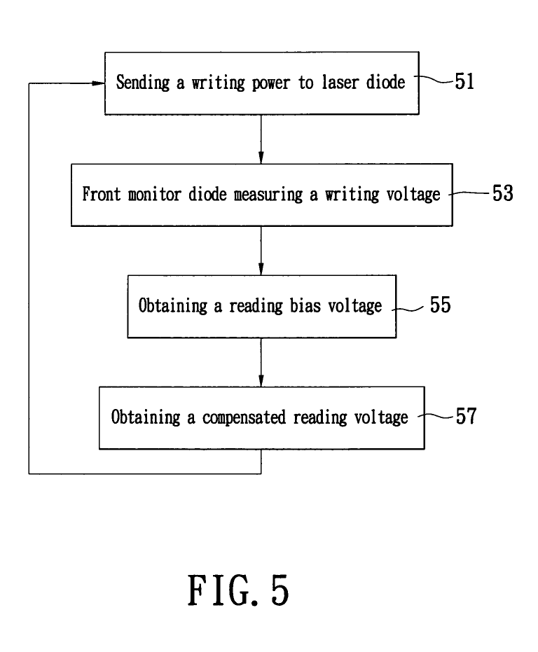

FIG. 5 shows the flowchart of the compensating method according to the present invention, which comprises the steps as follow. The auto power control system sends a writing power to the laser diode in writing state (step 51). The front monitor diode measures a writing voltage from the laser diode (step 53). A reading bias voltage is obtained with reference to the writing voltage and a lookup table (step 55). In reading state, a compensated reading voltage is then obtained and then the auto power control system sends the compensated reading voltage to a laser diode for producing a correct reading power (step 57). In the writing state, the process returns to step 51. Because the laser diode can produce a stable reading power during high power operation, the servo controller can produce correct parameters such as tracking error (TE) and focusing error (FE) signals.

In above step 55, the lookup table can be prepared by following two approaches in an offline manner:

1. The variation of tracking error (TE) signal is measured by varying the writing power. The peak value Vpp of TE signal is reduced in high power operation due to an incorrect reading voltage measured by the front monitor diode and a resulting incorrect reading power. The compensation value of reading voltage can be estimated by the reduction value of Vpp for establish the lookup table.

2. The variation of output from the front monitor diode is measured by varying the writing power. In general the reading power is kept to a constant value for providing servo signals. The deduction of reading power in high power operation indicates the limited time response of the front monitor diode. The compensation value of reading voltage can be estimated by the reduction value of reading voltage for establish the lookup table.

To sum up, the present invention provides a compensation method for a front monitor diode in high power operation. A lookup table is established by the above-mentioned two approaches. An incorrect reading voltage measured by the front monitor diode is compensated for by a reading bias voltage stored in the lookup table with reference to a writing voltage. Therefore, correct reading voltage and reading power are produced in high power operation. The servo controller can produce stable servo signals to ensure recording quality.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A compensation method used in an optical disk drive, comprising steps of:
the front monitor diode measuring a writing voltage from a laser diode;
obtaining a reading bias voltage from a lookup table, the lookup table being prepared offline by measuring a reduction of reading voltage of the front monitor diode for a specific writing voltage; and
an auto power control unit sending a compensated reading power to the laser diode.

2. The compensation method as in claim 1, wherein the auto power control unit sends a writing power to the laser diode when the laser diode is in writing state.

3. The compensation method as in claim 1, wherein the reading bias voltage is obtained from the lookup table with interpolation.

4. The compensation method as in claim 1, wherein the auto power control unit sends a compensated reading voltage to the laser diode in a reading state.

5. The compensation method as in claim 1, wherein the auto power control unit produces-a compensated reading voltage with reference to the reading bias voltage.

6. The compensation method of as in claim 1, wherein the lookup table is prepared by monitoring a variation of TE signal in an offline manner.

7. The compensation method as in claim 1, wherein the lookup table is prepared by monitoring a variation of reading voltage in an offline manner.

8. A compensation method used in an optical disk drive, comprising steps of:
the front monitor diode measuring a writing voltage from a laser diode;
obtaining a reading bias voltage with reference to the writing voltage; and
an auto power control unit sending a compensated reading power to the laser diode.

9. The compensation method as in claim 8, wherein the auto power control unit sends a writing power to the laser diode when the laser diode is in a writing state.

10. The compensation method as in claim 8, wherein the reading bias voltage is obtained from the lookup table with interpolation.

11. The compensation method as in claim 8, wherein the auto power control unit sends a compensated reading voltage to the laser diode in a reading state.

12. The compensation method as in claim 8, wherein the reading bias voltage is obtained from a lookup table, the lookup table being prepared offline by measuring a reduction of reading voltage of the front monitor diode for a specific writing voltage.

13. The compensation method as in claim 8, wherein the auto power control unit produces the compensated reading voltage with reference to the reading bias voltage.

14. The compensation method as in claim 12, wherein the lookup table is prepared by monitoring a variation of TE signal in an offline manner.

15. The compensation method as in claim 12, wherein the lookup table is prepared by monitoring a variation of reading voltage in an offline manner.
